(19) United States
(12) Patent Application Publication
(10) Pub. No.: US 2003/0227482 A1
(43) Pub. Date: Dec. 11, 2003

(54) User interface builder

(76) Inventors: Thomas Bach, Muehlhausen (DE); Steffen Tatzel, Nussloch (DE); Martin Semmler, Angelbachtal (DE); Rainer Brendle, Neckargemund (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/389,271

(22) Filed: Mar. 14, 2003

Related U.S. Application Data
(60) Provisional application No. 60/386,476, filed on Jun. 5, 2002.
(60) Provisional application No. 60/386,320, filed on Jun. 5, 2002.

(51) Int. Cl. G09G 5/00

(52) U.S. Cl. 345/762

(57) ABSTRACT

A user interface with a main controller and subcontrollers nested within the main controller. The main controller refers to blueprint tables to instantiate and manage the subcontrollers. The subcontrollers are responsible for generating view components displayable in client devices. The main controller receives requests from client devices and manages the communications between subcontrollers, and between a subcontroller and a model of business data and logic. One or more subcontrollers and their respective views may form a container for data management on the screen. The main controller assembles the views from the subcontrollers into a page and transmits it to the client device. A user interface builder for defining blueprint tables is also disclosed.

### CROSS REFERENCE TO RELATED APPLICATIONS

This application claims priority from U.S. Provisional Application Ser. No. 60/386,476, filed Jun. 5, 2002, which is incorporated herein by reference in its entirety. This application also claims priority from U.S. Provisional Application Ser. No. 60/386,320, filed Jun. 5, 2002, which is incorporated herein by reference in its entirety.

### TECHNICAL FIELD

This application relates to computer user interfaces.

### BACKGROUND

User interface programs facilitate the interaction between humans and machines by inviting and responding to interaction from a user. User interfaces come in many varieties, and are designed to work in concert with an application program. Some user interface programs, or modules, are a common program or module for several different application programs. With such a design, user interface program modules common to several application programs need not be duplicated in each of the application programs. In addition, such a design may enable a common “look-and-feel” to the user interface for different program applications.

A common situation involving user interfaces is a network connection between a server and one or more clients. The client/server relationship is one in which a server provides services to other computer programs in the same or other computers, the client devices. Both the clients and the server typically have a network interface for accessing networks such as a local area network (LAN), a wide area network (WAN), or the Internet.

A common client device is a personal computer running a web browser application program. The browser allows networked communication between the client device and a server using the Hypertext Transfer Protocol (HTTP) to exchange files, images, or programs. HTTP is a request/response type protocol that specifies how the client and the server communicate with each other. The server may receive a request from the browser using HTTP, respond to it, and then close the connection. HTTP is a stateless protocol, meaning that each time a client requests a web page, the server will respond to the request independently of any previous requests by the client, and without recording the request.

The contents of a file transmitted from the server and intended for display in a browser on the client device may be marked up with Hypertext Markup Language (HTML) code. HTML is a language that is used to describe the structure of a document, such as a web page. Browsers interpret the HTML code to determine how to display the information contained therein.

A user may request a web page from a server by clicking a hyperlink or entering a Uniform Resource Locator (URL) string. A URL is the address of a file that may be accessed on the Internet, including the web server it is stored on and the directory it is located in. When the server receiving the URL request finds the sought web page, it sends the page in return to the browser for display.

Some requests from the browser require the server to access one or more databases. One type of database is a relational database, typically having columns for fields and rows of field values. The table contains the keys of the attributes, the field values, of the various columns of the table. Keys allow for associations between tables, such that following the reading of an entry in one table is a query of another table containing information related to the entry.

### SUMMARY OF THE INVENTION

The invention relates to building user interfaces. The invention can be implemented in methods and apparatus, including in computer program products. In one general aspect, the invention provides an apparatus for building a user interface for a software application program. The apparatus comprises a repository of preconfigured layout shells for generating user interface displays for software application programs. The preconfigured layout shells are independent of the software application programs. The apparatus comprises a building module wherein a user can select one of the preconfigured layout shells for building a user interface. The building module uses the selected layout shell to build the user interface.

In some implementations, the apparatus provides previewing of the user interface display. Such viewing may be provided by a viewing module coupled to the layout shells, and it may involve using live application data.

Some implementations may be used to build new user interfaces and to generate a modified user interface from an existing user interface. In the latter case, the existing user interface may remain unaltered after the modified user interface has been built. When a user modifies an existing user interface, the apparatus may provide that the user's changes take precedence over certain existing layout features. The view component generated from the selected layout shell may be displayed in lieu of a specified view component in the existing user interface.

In another general aspect, the invention provides a repository comprising preconfigured layout shells. The layout shells can be used to generate user interfaces for software application programs. The layout shells are independent of the software application programs. A user can select a layout shell in the repository to generate a user interface.

In another general aspect, the invention provides a method of building a user interface for a software application program. The method comprises selecting one of a set of preconfigured layout shells for generating user interface displays for a software application program. The preconfigured layout shells are independent of the software application program. The selected preconfigured layout shell is used to build the user interface.

Advantages of the invention may include one or more of the following. Providing improved building of user interfaces. Providing improved modification of existing user interfaces. Providing a user interface that is independent of the software application program. Providing a user interface that can be modified without necessitating reprogramming of the application program. Providing a user interface that can easily be applied to more than one application program. Providing a user interface that allows application programs to deactivate tabs or toolbars at runtime.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 is an overview diagram of a system with a user interface;

FIG. 2 is an architecture of a user interface;

FIG. 3 schematically shows subcontrollers launched by a main controller;

FIG. 4 are steps that may be carried out when an application is launched via the user interface;

FIG. 5 is an architecture of an object identification container and an object data container;

FIG. 6 are steps that may be carried out when a server receives a search request;

FIG. 7A shows the logical flow of control between controllers and a model;

FIG. 7B shows information flow between controllers and a model;

FIG. 8A are steps that may be carried out when creating blueprint tables;

FIG. 8B schematically shows a user interface defined as a subset of an application set;

FIG. 9 is an exemplary screen shot of a user interface;

FIGS. 10A and 10B are further exemplary screen shots of a user interface;

FIG. 11 is a display element with a field group;

FIGS. 12A and 12B schematically show the appearance of a temporary communication area;

FIGS. 13A and 13B are further exemplary screen shots of a user interface;

FIG. 14 is a screen shot of a blueprint application builder; and

FIG. 15 is an overview diagram of a system with a user interface builder.

Like reference symbols in the various drawings indicate like elements.

### DETAILED DESCRIPTION

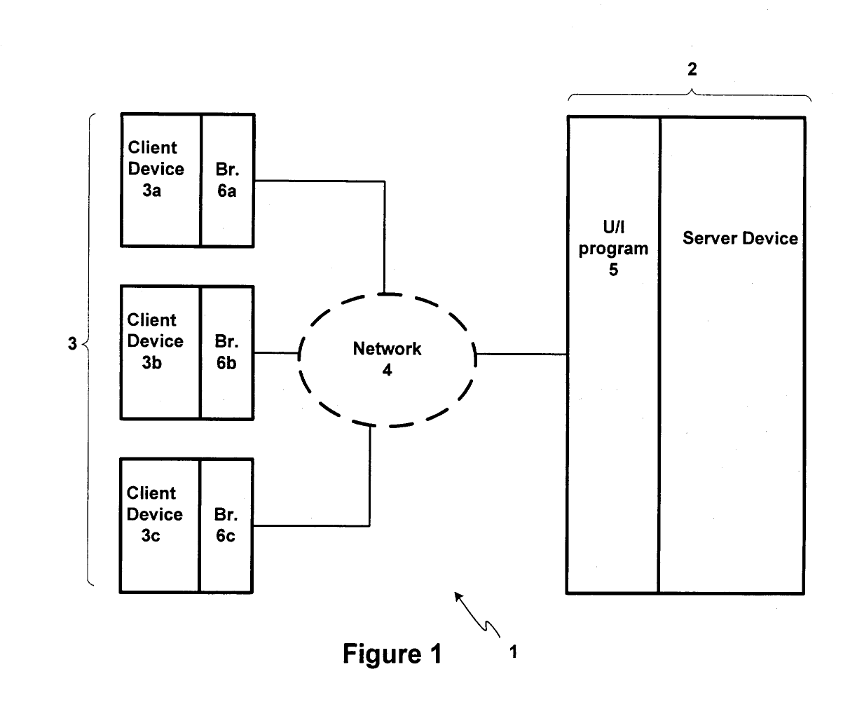

Embodiments of the invention may be implemented in computer networks. FIG. 1 schematically shows a system 1 including a server device 2 and client devices 3a-3c connected by a network 4. The network 4 may be a LAN, WAN, the Internet, or other network. A user interface program 5 allows users to input information into, and receive information from, the server device 2. Client devices 3 include respective browsers 6a-6c, which may be conventional browsers such as Netscape Navigator or Microsoft Internet Explorer.

An organization may implement the system 1 to handle data management in some or all of the organization's business activities. One example is a system that manages the organization's sales data, service information and customer records, among other things. Such systems are sometimes referred to as Customer Relations Management (CRM) systems. Employees with access to the CRM system may work with the organization's data using the client devices 3. The server 2 may then be referred to as a CRM server.

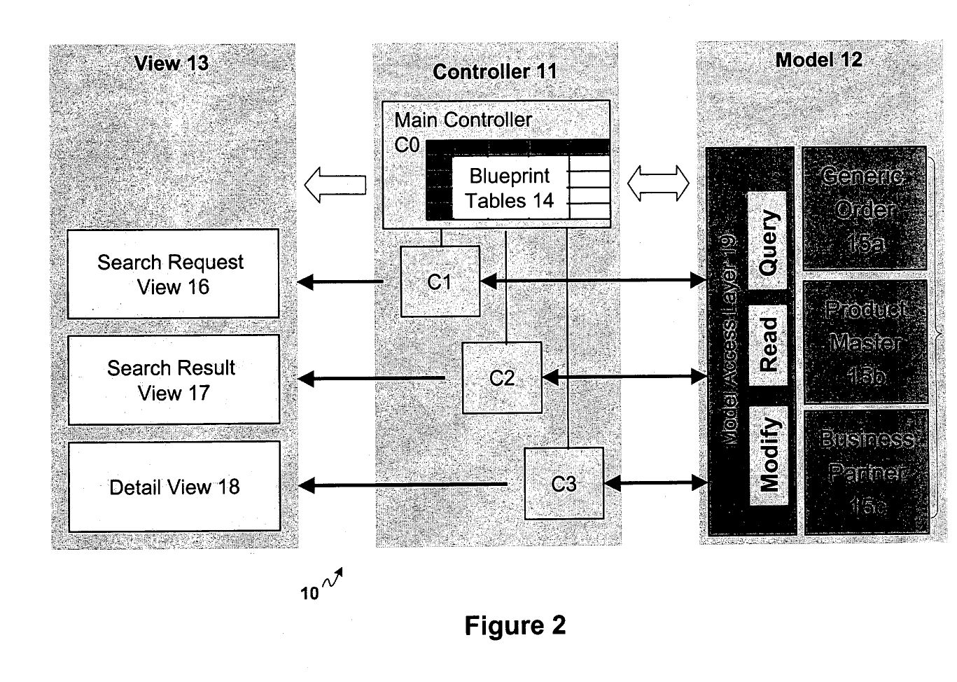

FIG. 2 is a block diagram a user interface architecture 10 that may be used in a CRM server. The architecture 10 employs the Model-View-Controller (MVC) principle, a strategy in object-oriented programming for separating presentation of data from data maintenance. In MVC frameworks, the model is the representation of the logical structure of data in an application. The view includes rendering logic for generating view components that can be displayed on the screen in the client, and the controller consists of all object classes for communicating between the model and the view. The architecture 10 includes a controller 11 capable of accessing business data existing in a model 12 and preparing the data for display using a view 13. As will be described below, the architecture 10 may be configured such that the model 12 is not permitted to query the controller 11 for user interface information. This may provide the benefit that modification of the resulting user interface does not require reprogramming of the software application program(s) making up the model 12.

The controller 11 has a multi-layer structure: a main controller C0 and several subcontrollers C1, C2, C3, . . . nested within the main controller. As will be described below, each subcontroller is responsible for producing and maintaining a specific view and for transporting that view's data to and from the model 12, and the main controller manages communication with the client. The main controller and the subcontrollers may be implemented as instructions executable by a processor in a system that embodies the architecture 10. It will also be described below that an interface between the controller 11 and the model 12 may be common to all subcontrollers.

The main controller instantiates the subcontrollers and is responsible for their communications. The subcontrollers may be nested within the main controller C0. The main controller obtains instructions from configuration—“blueprint”—tables 14, a family of interrelated database tables containing information on the configuration of subcontrollers, the characteristics of the views, rules for communications with the model, etc. The main controller is the only controller that reads the blueprint tables.

The model 12 as shown includes three application programs 15. In this exemplary implementation, they are an order management program 15a, a product specification program 15b and a business partner program 15c for maintaining associated records on customers, employees, competitors, etc. Typically, application programs 15 include databases of business data, which data should be available to persons in the organization. In other implementations, the model 12 may include many more and different application programs, all of which become accessible through the user interface. Thus, very large amounts of data may potentially exist in the model 12.

The controller 11 accesses the model 12 using standardized methods that are compatible with the applications 15. A model access layer 19 is characterized by which standardized methods it recognizes, three of which are named: QUERY, READ and MODIFY.

The view 13 as shown includes a search request view 16 for searching data in the model, a search result view 17 for displaying results of searches in the model, and a detail view 18 showing details of objects listed in the result view 17. Each view is built by one of the subcontrollers. The views include view components for display on client devices. For example, a view may render a view component displayable as a pane on a screen of the client device. The views may consist of elements generated by the Business Server Pages application from SAP AG, Walldorf, Germany (“BSP elements”), which elements incorporate “HTMLB” web controls developed by SAP.

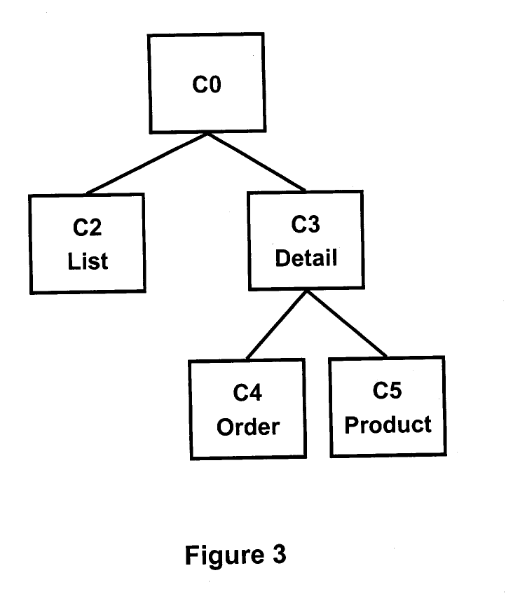

The subcontrollers C1, C2 and C3 are not the only subcontrollers that may operate within the architecture 10. Nor are views 16, 17 and 18 the only possible views. Rather, any number of subcontrollers, and corresponding views, may be included in the architecture. FIG. 3 schematically illustrates a multi-level controller structure where the main controller C0 instantiates subcontroller C2 to build a list view and subcontroller C3 to build a detail view. The subcontroller C3 is also responsible for calling two additional controllers C4 and C5 to build an order view and product view, respectively. In this sense, there are three levels of hierarchy instead of two levels as shown in FIG. 2. The subcontrollers C4 and C5 are “child” controllers of the subcontroller C3. As will be described later, this may affect their communication with each other and with other subcontrollers, and the generation of their respective views.

The architecture 10 may be implemented in a system 1 (FIG. 1) to provide a user interface for a browser-based CRM system. In such a system, users may access the CRM server via browsers 6 on remotely located computers (the client devices 3) to work with data in any or all of the application programs in the model. The users may then see and interact with images received from the CRM server and displayed in the browsers 6.

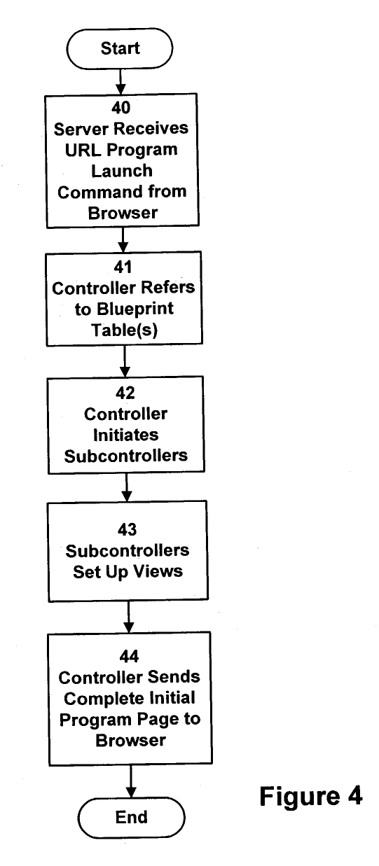

FIG. 4 shows steps that may be carried out when a user seeks to launch an application on the CRM server. The user may do this by causing the browser to transmit a URL request to the CRM server for the application. The URL may include an address of the CRM server (more than one server may exist in the network), the name of the application and a command indicating to the server that the application should be initialized. The requested application may be, for example, a business partner program for maintaining associated records on customers, employees, competitors, etc., which may be identified in the browser request as COMM_BP. The initiation command may be INIT.

In step 40, the server receives the URL request and the additional information, and then passes them to the main controller. The main controller reads the COMM_BP and INIT commands and interprets them as a request to launch the business partner application. Referring to the blueprint tables in step 41, the main controller determines what views are to be initially displayed in the business partner application program. Using this information, the main controller initiates the subcontrollers in step 42. The subcontrollers, in turn, configure in step 43 the respective views corresponding to the configuration for the views. The main controller then assembles the view components corresponding to the configured views into a complete page and transmits that page to the browser in step 44. The browser then displays the page—the initial view of the business partner application-on its screen.

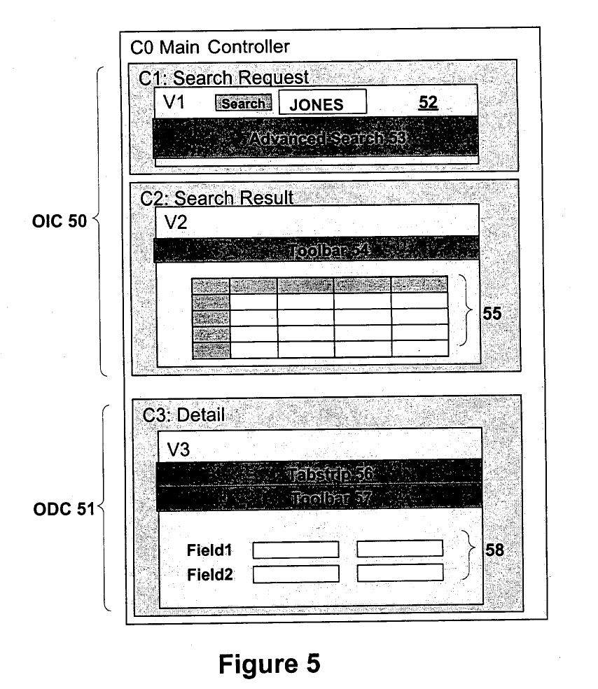

The views of different subcontrollers may have different purposes. FIG. 5 is a conceptual depiction of the controller and subcontrollers, and illustrates the panes of the different views generated by the subcontrollers. In this example, there is a search request view pane (V1), a search result view pane (V2), and a detail view pane (V3) in the order they may appear on a display screen. Each view pane is shown in front of its associated subcontroller to illustrate conceptually the correspondence between the subcontrollers and views. The subcontrollers, in turn, are shown in front of the main controller C0, to illustrate conceptually the hierarchy of the controller and subcontrollers.

The search request view pane (V1) allows a user to search the business partner application. The search result view pane (V2) displays the results of such a search. The search request and search result view panes may be collectively referred to as an object identification container (OIC) 50 that facilitates searching for objects and presenting the results. The search request view pane V1 includes a toolbar 52 with a text entry field and a button labeled “Search” for executing the search. The view pane also includes an advanced search function 53 which will be described later. The search result view pane V2 includes a toolbar 54 and a list 55 of objects responsive to the search. The list 55, in this example, is in the form of a spreadsheet display. By way of example, different objects may be in different rows, and the columns may have different fields for the objects. Thus, the OIC 50 comprises the view panes V1 and V2 and their respective controllers C1 and C2.

The detail view pane V3 and its subcontroller C3 together are an example of an object data container (ODC) 51 because they are capable of displaying the detail about a selected object listed in the OIC. Typically, the ODC displays data about one object at a time, the one selected in the OIC. Selecting another object in the OIC may cause the ODC to change its view. The ODC includes a tab strip 56—row of activatable tabs for selecting different instances of the view—and a toolbar 57. A group 58 of field boxes in the detail view pane displays object data.

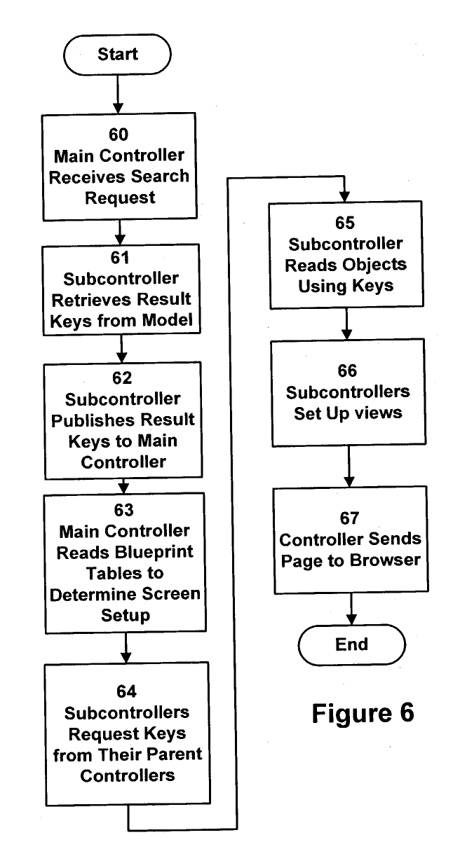

It will now be briefly described how the OIC and the ODC are used in the process of performing a database search and displaying of results. FIG. 6 shows steps that may be carried out in such a procedure. An exemplary search request may be directed at all business partners including the name “Jones” as entered in the search field of the OIC 50 (FIG. 5).

In step 60, the main controller receives the search request from the browser. The need for searching in the application database means that the subcontroller C1 contacts the model with the QUERY method. The application in this case identifies all business partner objects that include the name Jones. For each such business partner object, the application in step 61 returns the object key—a unique identifier for the object—to the subcontroller, which buffers it in memory. The subcontroller also publishes the list of keys to the main controller in step 62.

In step 63, the main controller reads the blueprint tables to determine the screen setup. If any additional subcontroller is needed to build the appropriate view, the main controller initiates it. The subcontrollers in step 64 request the object keys from their parent controllers, which are the respective controllers above each subcontroller in the hierarchy (FIG. 3). That is, each child controller requests the object keys from its parent controller. This communication is made via the main controller. In step 65, the search result subcontroller C2 (responsible for the search result view) reads the data objects from the model by using the “READ” method with the keys as parameters. Having received the objects responsive to the search, the subcontrollers configure their respective views in step 66 according to their configuration. The main controller then assembles the views into a complete page, and in step 67 sends the page to the browser. The logical flow of control in the initiate and read/modify processes will now be described.

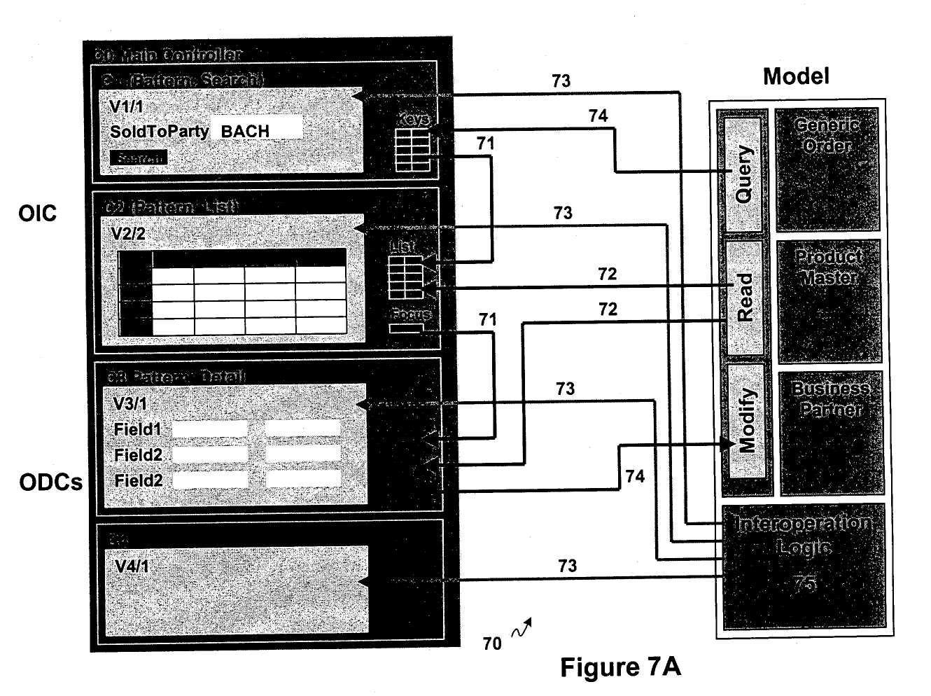

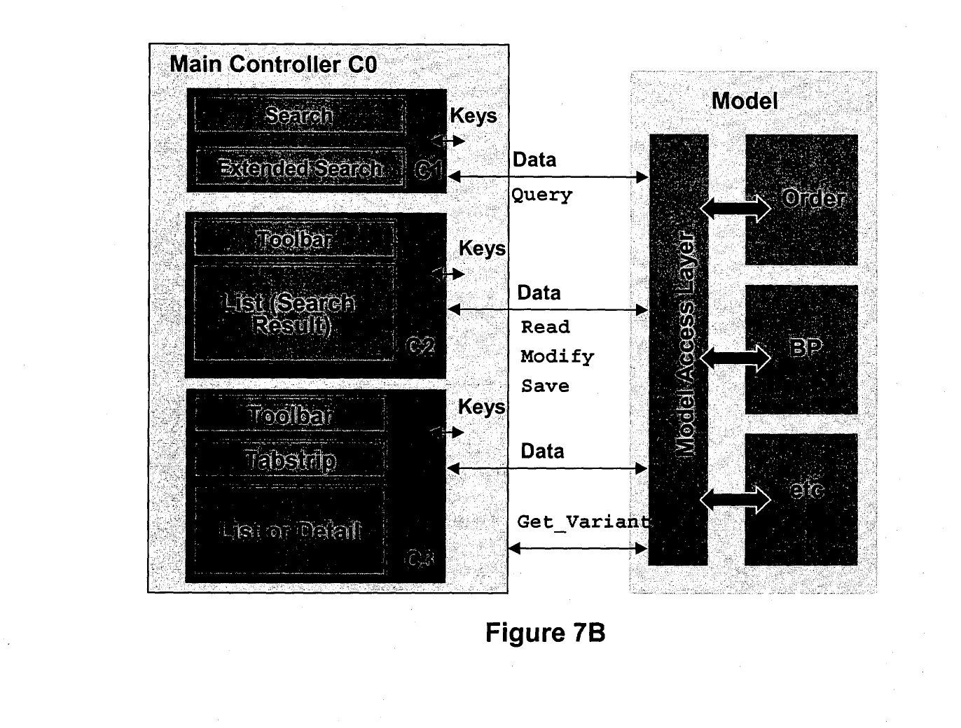

FIG. 7A is a conceptual depiction of an architecture 70 that includes controllers, views and a model. The view panes (V1, V2, V3) are shown in front of their respective subcontrollers (C1, C2, C3), and the subcontrollers are shown in front of the main controller C0. The model is shown associated with an interoperation logic 75, that provides the underlying base for interoperation of the application programs. Among other things, the interoperation logic 75 may include a relational database management system. The interoperation logic 75 may, for example, be provided by the basis technology which is a set of programs and tools from SAP for providing interoperability between application programs. Arrows going in either direction between the model and the controller/views represent control flows.

The following flows occur before the main controller makes a display output. The subcontrollers are initiated by the main controller in response to a URL request. The subcontrollers then request and receive keys from their parent controllers via the main controller in flow 71. Specifically, the search result subcontroller C2 requests from subcontroller C1 the keys for objects that are to be listed in C2, and the detail subcontroller C3 requests a focus key from C2. When an application is initiated, a default query may be performed, resulting in object keys responsive to the default query being provided to the subcontrollers.

The subcontrollers request and receive data from the model in flow 72. Specifically, the subcontrollers C2 and C3 request object data using the model access method “READ”. The subcontrollers will use the received data to populate the search result list.

In flow 73, the views retrieve data dictionary (DDIC) information from the interoperation logic 75. The DDIC information contains descriptions (labels) of the data objects in the model. The DDIC structure defines for the subcontrollers what data is exchanged with the model and displayed in the view. Specific DDIC structures are referred to as screen structures and will be described later.

The following flow occurs in the processing following an input from the browser (such as a search request or a modification of object data). In flow 74, the appropriate subcontroller calls the model with the “QUERY” or the “MODIFY” method as applicable. After the result list of keys are buffered in the subcontroller's memory, the subcontrollers obtain data objects and build the new views analogous to flows 71, 72 and 73 above.

The main controller, subcontrollers and the model follow rules for their respective communications. FIG. 7B illustrates possible communications between the controllers (shown similarly as in FIG. 7A) and the model. The subcontrollers C1, C2 and C3 communicate only with the main controller C0 and with the model. The subcontrollers exchange only keys (that is, no application data) between each other, and this communication takes place via the main controller. The subcontrollers exchange data (object attributes) with the model, using methods such as QUERY, READ, MODIFY and SAVE. For example, subcontroller C1 may access the model using the QUERY command. Subcontrollers C2 and C3 may access the model using the READ, MODIFY and SAVE commands. The main controller can access the model using the Get_Variant method, which permits the subcontrollers to set up alternative screens for the same event. Screen variants may be defined in the blueprint tables and are used, for example, when an address can be displayed in different ways.

### Blueprint Tables

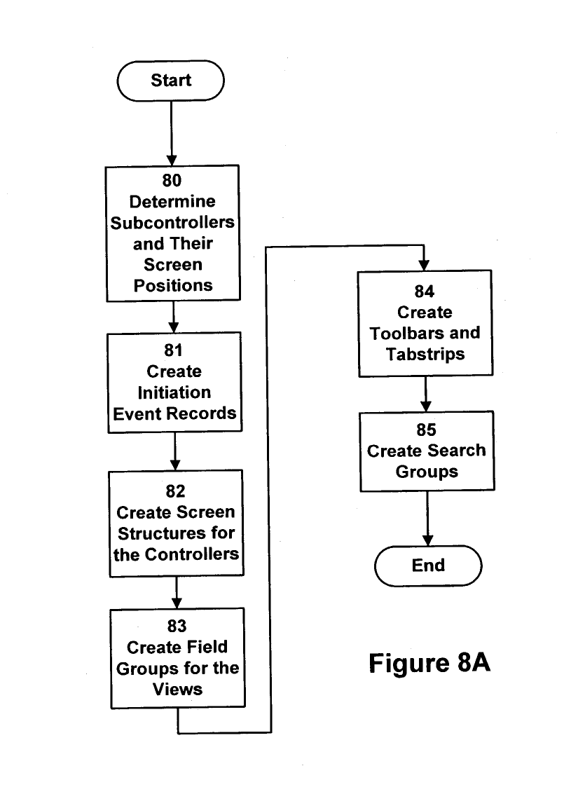

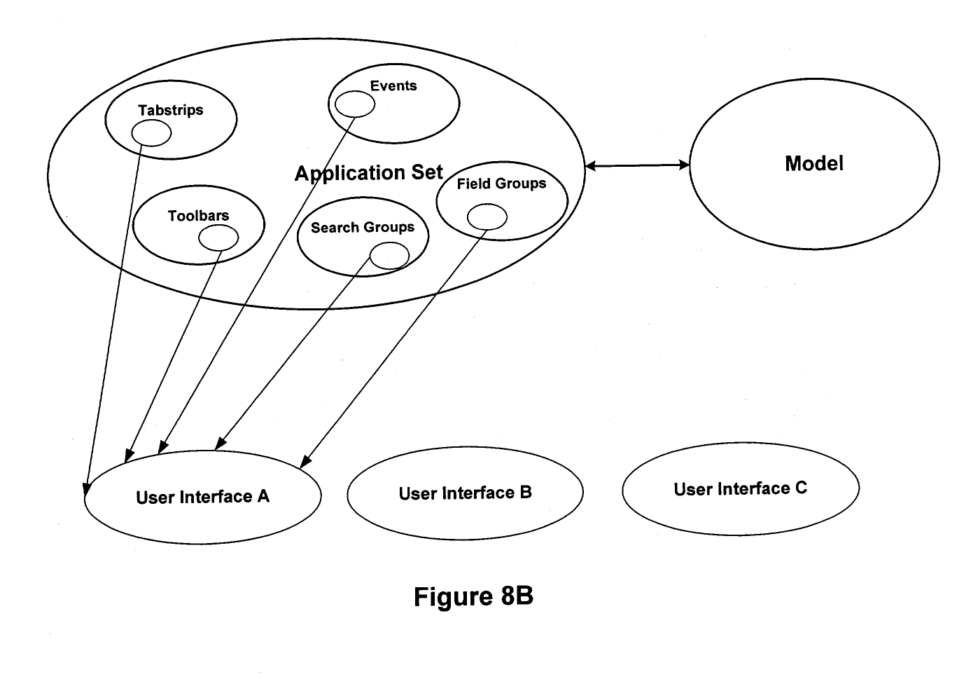

Entries for the blueprint tables 14 (FIG. 2) are created, during development, for every application in the model that the user interface should interact with. FIG. 8A shows basic steps 80-85 that may be performed when creating a blueprint table. The developer determines the subcontrollers and defines their screen positions (step 80), and records their initiation events (step 81). Screen structures (definitions of data exchangeable with the model) are defined and associated with the controllers (step 82). Field groups (collections of the data fields to appear in a view) are defined for the views of the respective subcontrollers (step 83). Toolbars and tab strips (sets of tabs for choosing between instances of a view) are created for the different views (step 84). Also, search groups (definitions of search functions) are created and stored in the blueprint tables (step 85).

From this overview, it can be seen that a user interface is characterized by the field groups, events, toolbars, etc., which have been associated with it in the blueprint tables. To the extent that the elements of these groups determine the layout of the application when it is displayed in the user interface, they may be considered to be layout shells for the application. When a layout shell is provided with application data, it can be displayed in the user interface of the application.

The toolbars, etc., that a user interface uses may, in some cases, be only a subset of those available in the architecture. Accordingly, the user interface is defined by the particular instances of these groups with which it is associated. FIG. 8B is a conceptual diagram showing a user interface A defined by subsets of the respective toolbar, tab strip and event groups, search groups and field groups, etc. The collective set of all toolbars, tab strips, etc. is the application set. The application set consists of all objects that are compatible with the model. Therefore, other user interfaces B, C, etc. for the same model can be defined from the application set.

The application set may be independent of the model. For example, the groups included in the application set may be independent of the model in that they were not created together with any software application of the model. Rather, the application set may be independent of the model and of the software application programs making up the model.

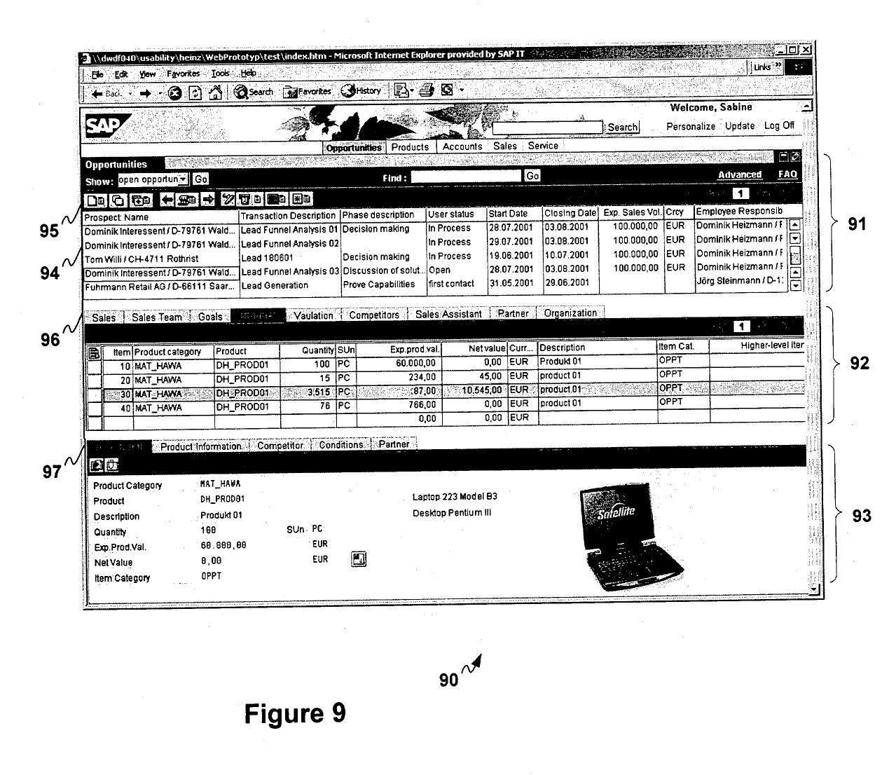

FIG. 9 is a screenshot of a portal 90 that makes a number of applications available to a user through a browser. The applications may be provided with role-dependant logic, whereby the portal can automatically display a version of the application that is appropriate for the particular user. In the FIG. 9 example, the portal is displaying an exemplary Opportunities application for managing business opportunities.

The application user interface 90 includes an OIC display 91 and two ODC displays 92 and 93. The OIC has performed a query for the user to find all “open opportunities,” and the OIC display shows a list 94 of such opportunity objects. The ODC displays 92 and 93 show further details of a selected opportunity. The OIC display includes a toolbar 95 and the ODC displays include respective tab strips 96 and 97. Had another of the applications been selected in the portal 90, a user interface display for that application would appear, which may, e.g., contain an OIC display and one or more ODC displays, also showing objects. For example, in a Product or Accounts application, the user interface display may be product objects or account objects, respectively, all in accordance with the blueprint tables for the particular application.

Contents of the blueprint tables for an exemplary application will now be described. In the example that will be described, the main blueprint table may be named CRMC_BLUEPRINT. This table is provided with initiation event records for each subcontroller and also contains specifics of every event that may occur in the application, which may include references to other blueprint tables. The INIT records inform the main controller, when it reads the blueprint table, how to initiate subcontrollers for the initial display of the application. A business partner application, for example, which manages business partner records, may be referred to as COMM_BP and its initiation events may be listed as follows:

TABLE 1
CRMC_BLUEPRINT.

| Application | Event | Screen Position | Screen Variant | Screen Type |
|---|---|---|---|---|
| COMM_BP | INIT | 1 | | SREQ |
| COMM_BP | INIT | 2 | | SRES |
| COMM_BP | INIT | 3 | | LIST |

The application name COMM_BP is listed in the Application column, and the Event column indicates that these records pertain to the INIT event, typically triggered by the initial request for the application to be launched. Thus, when the browser sends a URL request containing the name of the business partner application and the initiation event, the main controller looks up these rows in the blueprint table. More columns will be added to the blueprint table in the discussion below. The blueprint table refers to the subcontrollers as Screen Types.

### Screen Types and Screen Positions

The Screen Type and Screen Position columns in the blueprint table shown in Table 1 convey the information regarding which of the subcontrollers are to be initiated and in what screen position, when the business partner application is initiated. The first row of the blueprint table defines that the search request subcontroller (SREQ) should be instantiated and that the display it produces will be displayed in screen position 1. The available screen display is divided in four screen positions, numbered 1, 2, 3 and 4 from the top. Subcontroller C1 in FIG. 7A is displayed in screen position 1. The second row defines that the search result subcontroller (SRES) should be instantiated and that the display it produces will be displayed in screen position 2 (below screen position 1). The third row defines that the result detail subcontroller (LIST) should be instantiated and that the display it produces will be displayed in screen position 3 (below screen position 2). It is preferable that the search request subcontroller is allowed only in screen position 1 and the search result subcontroller only in screen position 2. Likewise, the detail subcontroller is preferably allowed only in screen positions 3 and 4. It will be described later how screen positions may be hierarchical, whereby an event affects only the items in the blueprint table having the same or greater screen position number.

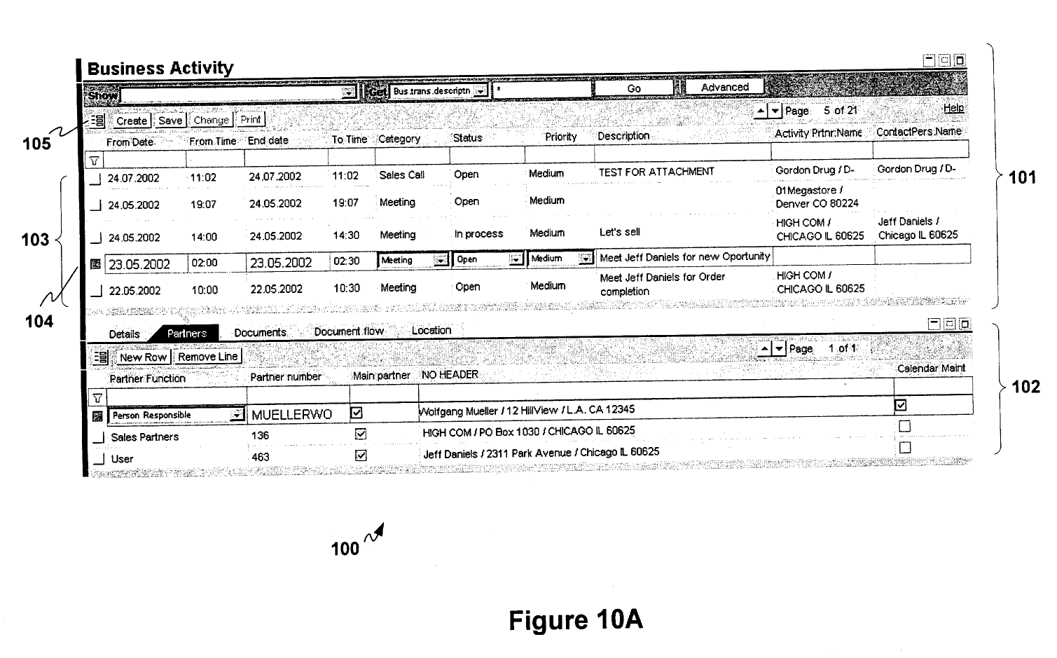

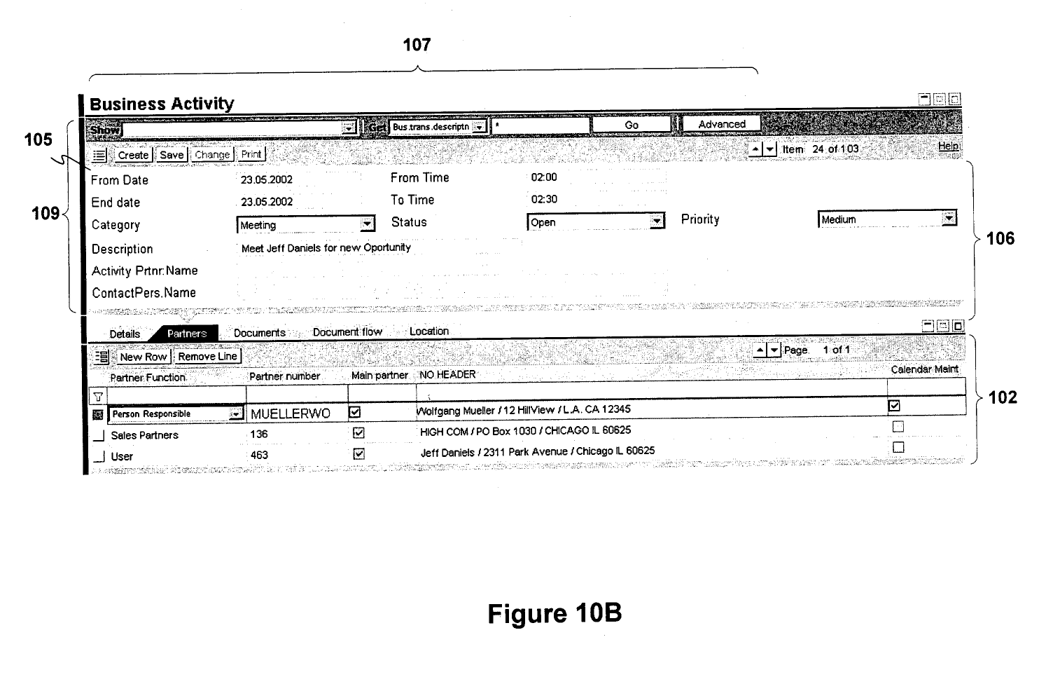

FIG. 10A shows an example of how a view pane 100 relating to business activities may be created on a client device by subcontrollers. Two subcontrollers (search request subcontroller SREQ and search result subcontroller SRES) create an OIC display 101 in the two upper screen positions. A LIST subcontroller creates an ODC display 102 beneath them. The OIC display 101 includes a list of search results 103 of business activity objects, of which object 104 has been selected. The OIC display 101 also has a toggle button 105 to switch from the list display into a form display where the OIC displays only one (selected) object.

FIG. 10B shows the view pane 100 with an OIC display 109 in form view after activation of the button 105. The subcontroller FORM is responsible for building the form view. The form 106 displays the data of the selected object 104, including some data that was not visible in list view. The OIC display 109 does not display any of the other objects. Switching from list view to form view changes the appearance of the button 105. If the button is again activated, the OIC display will return to list view and the button will resume its previous appearance. It may be possible to edit the object both in list and form view. A search function area 107 appears toward the top of the OIC. Search functions will be described below.

Subcontrollers or screen types other than the ones mentioned above are possible. For example, a CM subcontroller may handle content management, a survey tool may be implemented by a SURV subcontroller, and text management may be handled by a TEXT subcontroller. The layout of views generated by subcontrollers may be defined by Field Groups.

### Field Groups

Field groups determine how fields are displayed in a view. This may involve defining the order of the fields, their attributes such as whether they are hidden, whether they are grouped with other fields, and whether the field has a frame. Using different field groups, a set of fields can be displayed in many different ways. The following are examples of attributes that may be assigned to fields:

TABLE 2
Custom attributes for fields.

| Display Attribute | Description |
|---|---|
| Fieldgroup (KEY) | Alphanumeric key field. |
| Screenposition | Numeric key field that identifies the sequential posi- |
| (KEY) | tion within a set of the fieldgroup. |
| Referencegroup | A recursive foreign key used to nest sub-field groups. |
| Grouptype | The style of the reference group: Radiobuttongroup; |
| | Meltinggroup, etc. |
| Fieldname | Name of the DDIC structure's component. |
| Fieldtype | Type of field: Textfield (TXTF), Inputfield (INPF), |
| | Checkboxitem (CBIT), Image (IMAG) or |
| | Dropdownlistbox (DDLB) and Radiobuttongroup |
| | (RBGR). |
| Hidden_List | Whether a field is hidden in the list display; the user |
| | can activate fields that are deactivated in the standard |
| | customizing table. |
| Hidden_Detail | Whether a field is hidden in the form display. |
| Readonly | If checked “x” then the field is read only. |
| Mandatory | If checked “x” then the field is mandatory. |
| Application_F4 | Application that will be displayed in a separate OIC |
| | as F4 help |
| Nolabel | If checked “x” then no label will display. |
| Default_Value | The initial value of the field. |
| Domain_Values | The fixed list obtained from value table. |
| Height_Detail | Sets row span in detail screen. |
| Length_Detail | Sets column span for text area and image |
| Length_List | Length of list screen. |

Adding the field group entries, the main blueprint table shown in Table 1 now is as follows:

TABLE 3
CRMC_BLUEPRINT.

| | | Screen | Screen | | |
|---|---|---|---|---|---|
| Application | Event | Position | Variant | Screen Type | Field Group |
| COMM_BP | INIT | 1 [OIC] | | SREQ | BP_search |
| COMM_BP | INIT | 2 [OIC] | | SRES | BP_list |
| COMM_BP | INIT | 3 [ODC] | | LIST | BP_detail |

It is seen that the SREQ, SRES and LIST screen types are associated with the field groups BP_search, BP_list, and BP_detail, respectively.

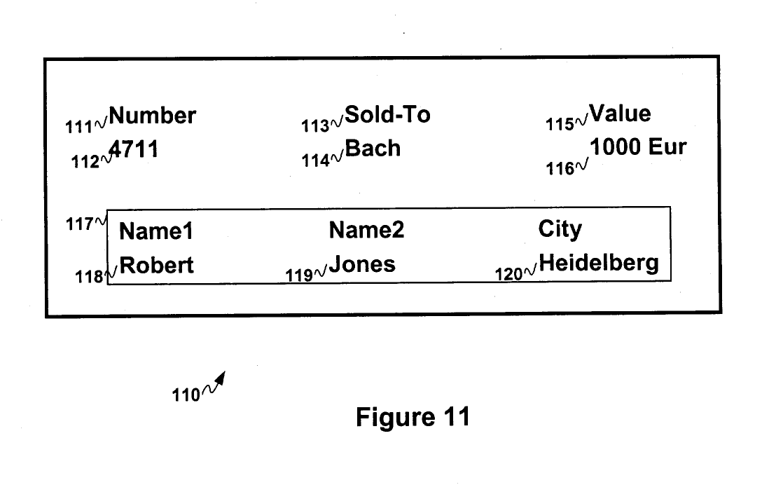

Examples of field groups and associated attributes will now be described with reference to FIG. 11. A view 110 may be displayed on the screen of a client device and includes a number heading 111 in combination with a number field 112. Similarly, a sold-to heading 113 is combined with a sold-to field 1114, and a value heading 115 with a value field 116.

As noted in Table 2 above, the reference group attribute allows sub-field groups to be nested in the field group. Also, fields can be associated with one of several group type attributes. A screen group (SCGR) 117 below the other fields contains two name fields 118 and 119, and a city field 120. Accordingly, the view 110 may indicate that an order for product number 4711 has been placed by customer Bach for a value of 1000 Euros, and that delivery is to be made to Robert Jones in the city of Heidelberg. The view 110 consists of an Order field group, built from the following field group table:

TABLE 4
CRMC_FIELDGRP.

| | | Reference | | |
|---|---|---|---|---|
| Field group | Screen Position | Group | Group Type | Field Name |
| Order | 01 | | | Number |
| Order | 02 | | | Sold-to |
| Order | 03 | Ord_Value | FMLT | |
| Order | 04 | Address | SCGR | |
| Ord_Value | 01 | | | Value |
| Ord_Value | 02 | | | Currency |
| Address | 01 | | | Name1 |
| Address | 02 | | | Name2 |
| Address | 03 | | | City |

Starting with the first row of Table 4, it declares that the number field (112) should be displayed in the first screen position of the Order field group, which is in the top left corner of the view 110 in FIG. 11. Similarly, the sold-to field should be displayed in the second screen position. The third screen position is populated with a “field melt” group type (FMLT), meaning that two fields are displayed closely side-by-side. Here, the two fields are represented by the reference group Ord_Value, which allows nesting of sub-field groups. The reference group Ord_Value is defined in the fifth and sixth rows of Table 4. Specifically, it includes a value field in its first screen position and a currency field in its second screen position. Thus, Table 8 here refers to two fields nested within the Ord_Value reference group, and declares that these fields should be “melted” together in the third screen position.

The fourth row of Table 4 refers to an Address reference group which should be displayed as a screen group (SCGR) in the fourth position of the Order field group. In the last three rows of Table 8, the Address reference group is defined as having the Name1 (118) and Name2 (119) field names in its first two screen positions, and the City field name in its third position. It can be seen in FIG. 11 that the field names 118, 119 and 120 are grouped together by the screen group 117 and on the display a frame appears around the group. A screen group may have a title denoting what fields are grouped within it, although no such title is displayed in the FIG. 11 example.

Other group types may be used. Logical group (LOGG) defines that two or more fields should be displayed together for semantic reasons, such as the starting and ending dates of a contract. Another possible group type is checkbox group (CBGR), which groups a number of checkbox fields together.

The blueprint tables list all events that may be triggered within the application, not merely the INIT event discussed above. One type of event is triggered when the user clicks on a tab that is displayed on the screen. For example, FIG. 9 shows an application 90 with a number of tabs in tab strips 96 and 97. A TAB event may have the following structure in the blueprint table:

TABLE 5
CRMC_BLUEPRINT.

| | | Screen | Screen | | |
|---|---|---|---|---|---|
| Application | Event | Position | Variant | Screen Type | Field Group |
| COMM_BP | TAB1 | 3 | | DETL | CON_DTL1 |
| COMM_BP | TAB2 | 3 | | DETL | CON_DTL2 |

Although the TAB1 and TAB2 events share the same screen structure, they may display different fields on the screen because they have different field groups. Assume, for example, that the field groups in Table 5 have the following definitions for fields Field1 and Field2:

TABLE 6
CRMC_FIELDGRP.

| Field Group | Field | Active |
|---|---|---|
| CON_DTL1 | Field1 | On |
| CON_DTL2 | Field1 | Off |
| CON_DTL1 | Field2 | On |
| CON_DTL2 | Field2 | On |

Thus, the TAB1 event which uses the field group CON_DTL1 will have both Field1 and Field2 active. In contrast, the TAB2 event will only have Field2 active.

The data that subcontrollers can exchange with the model and use in building a view is defined in Screen Structures.

### Screen Structures

Screen structures are the DDIC structures that are used in populating the application. The screen structure contains the fields that should be possible to display and maintain on the screen. Screen structures may be associated with field groups by a blueprint table:

TABLE 7
CRMC_fieldgre.

| Field Group | Screen Structure |
|---|---|
| BP_search | DDIC_search |
| BP_list | DDIC_list |
| BP_detail | DDIC_detail |

The screen structures determine what data each of the screen types (subcontrollers) can exchange with the model and display in its view. The fields used in the field groups must exist in the associated screen structure. The field groups, in turn, determine which data fields of a screen structure should be displayed, and where and how to do so. For example, a screen structure for the view 110 in FIG. 11 declares that the various fields 112, 114, 116, etc., are exchangeable with the model.

### Toolbars

Toolbars are used in applications to show and control sets of tools that the user may apply to objects. For example, FIG. 9 shows an application 90 with a toolbar 95. The tools may be displayed as buttons in the toolbar. Activating a tool button may require that some or all of the displayed view be updated, so the button is declared to trigger an event when pushed, which event may trigger a screen update at some point. A portion of the blueprint table may read as follows:

TABLE 8
CRMC_BLUEPRINT.

| | Screen | Screen | | | Toolbar |
|---|---|---|---|---|---|
| Event | Position | Variant | Screen Type | Field Group | Group |
| INIT | 1 | | SREQ | BP_search | |
| INIT | 2 | | SRES | EP_list | |
| INIT | 3 | | LIST | BP_detail | PRD_ODC1 |
| PRD_COND | 3 | | FORM | BP_detail_01 | PRD_ODC1 |
| PRD_TEXT | 3 | | LIST | BP_detail_02 | PRD_ODC1 |

Thus, upon initiation (the INIT event), the toolbar group PRD_{—ODC}1 is assigned to the view in the third screen position. This toolbar group is defined as being capable of triggering two events PRD_COND and PRD_TEXT in the following toolbar group table:

TABLE 9
CRMC_TOOLBARGR.

| Toolbar | | |
|---|---|---|
| Group | Sequence | Event |
| PRD_ODC1 | 01 | PRD_COND |
| PRD_ODC1 | 02 | PRD_TEXT |

Accordingly, the toolbar group PRD_ODC1 can give rise to two events: PRD_COND which changes the third screen position's screen structure to DDIC_detail_{—}01 and the screen type to FORM, and PRD_TEXT which changes the third screen position's screen structure to DDIC_detail_{—}02 and the screen type to LIST. The INIT event is not defined in the toolbar group, because it would cause the entire screen to rebuild when the tool is executed. The names of buttons (events) in toolbar groups may be kept in a text table.

When the user activates a toolbar button, the main controller dispatches the triggered event to the appropriate subcontroller, which in turn calls the model using the PROCESS_EVENT method, unless it is a local event for a tag, when the subcontroller processes the event without accessing the model.

### Tab Strips

Tab strips are sets of tabs capable of triggering events that shift a view between its specific instances. Tab strips are preferably positioned above the toolbar, if there is a toolbar in the view. For example, FIG. 5 shows an ODC display 51 where a tab strip 56 is displayed above a toolbar 57. A relevant portion of the blueprint table may read:

TABLE 10
CRMC_BLUEPRINT.

| | Screen | Screen | Screen | Field | Register Tab |
|---|---|---|---|---|---|
| Event | Position | Variant | Type | Group | Group |
| INIT | 1 | | SREQ | BP_search | |
| INIT | 2 | | SRES | BP_list | |
| INIT | 3 | | LIST | BP_detail | OPP_ODC1 |
| OPP_TAB1 | 3 | | FORM | BP_detail_01 | OPP_ODC1 |
| OPP_TAB2 | 3 | | LIST | BP_detail_02 | OPP_ODC1 |

Thus, upon initiation, the register tab group OPP_ODC1 is assigned to the view in the third screen position. This tab group is defined as capable of triggering the two events OPP_TAB1 and OPP_TAB2 in the following tab group table:

TABLE 11
CRMC_REGTABGRP.

| Tabgroup | Sequence | Event |
|---|---|---|
| OPP_ODC1 | 01 | OPP_TAB1 |
| OPP_ODC1 | 02 | OPP_TAB2 |

Accordingly, the tab strip group OPP_ODC1 can give rise to two events: OPP_TAB1 which changes the third screen position's screen type to FORM, and OPP_TAB2 which changes the third screen position's screen type to LIST. The INIT event is not defined in the tab group, because it would cause the entire screen to rebuild when the tab is activated. The names of tabs (events) may be kept in a text table. The events of the toolbar group and the tab group in the above examples cause the same changes in screen type and screen structure. In other implementations, tools and tabs may trigger significantly different events.

It has been mentioned above that screen positions may be hierarchical, whereby an event affects only the items in the blueprint table having the same or greater screen position number. For example, the just described tab events OPP_TAB1 and OPP_TAB2 have screen position 3 and therefore may cause an update of those items having a screen position 3 or 4. That is, when the screen type that generates a view in screen position 3 rebuilds its view, this may trigger a rebuilding of the views generated by other screen types having the same or a greater screen position number.

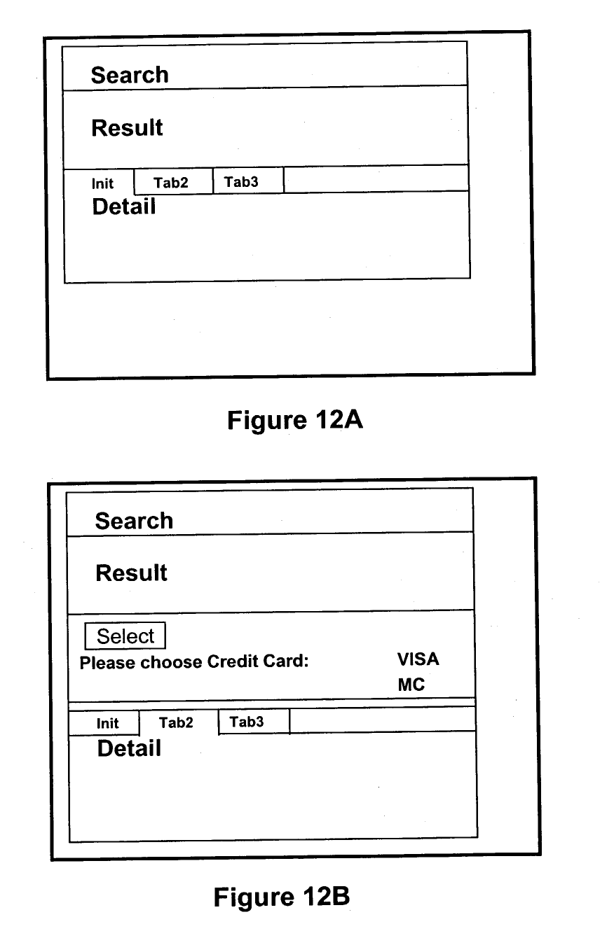

Another example of tab-triggered events will now be described. FIG. 12A shows an OIC display with search request and search result views, and an ODC display having a detail view with a tab strip. Currently, the “Init” tab is selected in the ODC display, possibly as a default upon initiation of the views. FIG. 12B shows the views after the user has activated Tab2 in the ODC display. A temporary communication area, or “pop-in” window, is displayed between the OIC and ODC displays, prompting the user to choose a brand of credit cards. The user interface made room for the temporary communication area on the screen by shifting the ODC display downward. A “Select” button in the temporary communication area allows the user to close the temporary communication area after making a selection. The ODC display then reverts to its initial position beneath the OIC display.

The just-described functionality may be implemented by a proper sequence of events and definitions in the blueprint tables. For example, the Tab2 event may be used to trigger an event requesting a temporary communication area to prompt the user for input. The blueprint table provides the temporary communication area with a tool button for triggering the event of closing the area and registering the user's input.

Another tab strip functionality that can be implemented using the blueprint tables is what may be referred to as a “viewswitch.” This involves replacing a number of related tabs in a tab strip with a drop-down-list box in a toolbar below the tab strip. This offers the advantage of being able to define multiple views within a single tab in a tab strip.

For example, assume that a number of tabs are chosen for a tab strip, including the tabs “competitor address,” “competitor price” and “competitor strategy.” Including all chosen tabs in the tab strip may make it prohibitively long and thereby render it less useful. A suitable solution may be to replace the three mentioned tabs with a single “competitor” tab in the tab strip, and create a viewswitch in the toolbar that lists the alternatives “address,” “price” and “strategy”. This tool preferably appears in the toolbar only when the competitor tab is selected. A tab strip may have more than one viewswitch.

### Customizing

The entries of the blueprint tables described herein may be only an initial configuration that is present in a system. It may be possible for a customer to edit the blueprint table entries to customize the system. A specific layer in the blueprint tables may facilitate the customization. Preferably, the system gives preference to blueprint table entries made by the customer over those of the system's initial configuration.

The following is a convenient procedure for managing customization. The customer may copy the entries of any blueprint table(s) for editing to suit the customer's needs. The customer edits the copied table entries to suit a particular application program that the customer intends to operate within the system. When the customer operates the system, it looks first for customer-specific entries and gives them preference over the initial entries that the customer copied during customization.

The customer can copy and edit blueprint table entries in different environments. One example is that the user may utilize the standard View Maintenance Module that is provided with certain SAP products. Various design tools may also be used. Yet another example is that an application builder may be used. An example of a “blueprint application builder” will be described later.

Preferably, the system is configured to sense whether changes are made pre- or post-development. That is, modification made by the customer can be distinguished from changes made during the development of the system. For example, the system may accept edits of the blueprint table entries during development and implement them as persistent changes of the blueprint tables. In contrast, the system may sense that it is a customer making the edits and store them in a “customer” layer of the blueprint tables. This may simplify the customization of an existing system. It may also make simpler the maintenance and service of a customized system.

### Searching

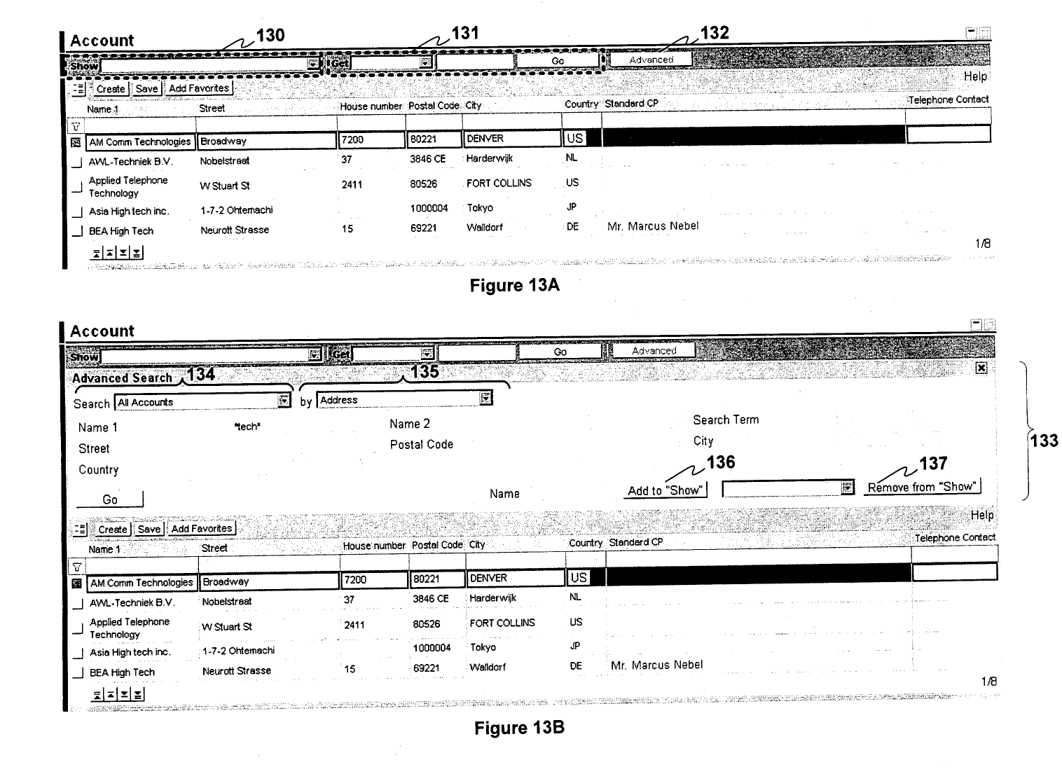

The OIC architecture offers several search functions for retrieving data objects from the model. Such search functions are described in a U.S. patent application Ser. No. 10/256,968, filed Sep. 27, 2002 and entitled “Database Access Mechanisms for a Computer User Interface.” The search functions will be described with reference first to FIG. 13A, where an OIC display shows “accounts” objects. The OIC display has a “Show” function 130, where a user can choose between predefined searches that appear in the field though the use of a drop-down box. The user may also add new searches to the Show field as will be described below. Activating a search listed in the Show field causes the search request controller to query the model for objects responsive to the search. When the search is complete, the OIC display shows a list of the search results.

A “Get” function 131 of the OIC allows the user to search for data objects by the contents of a particular field. Next to the Get label is a list box and a character entry field. The user can choose between field labels in the list box and enter a string in the character field. The OIC searches for objects having the entered character string in the selected field, and then displays the search results.

The OIC also offers an “Advanced” search function that can be invoked by pressing the “Advanced” button 132. FIG. 13B shows an advanced search area 133 in the OIC display. Unlike other view changes, the display of the advanced search area is not handled by the main controller; rather it is a local event in the search subcontroller.

Here, the advanced search area presents a number of fields such as “Name 1” and “City” where the user may enter search terms. This functionality is more advanced than the “Get” function because it allows several fields to be searched at the same time. Moreover, a “Search” drop-down list 134 allows the user to narrow the universe of objects to be searched. Instead of the currently selected “All Accounts,” the user may choose to search only in “active accounts” or perhaps “deleted accounts,” among other choices that may appear in the drop-down list box. Also, the collection of fields is not static. A “by” drop-down list 135 allows the user to select sets of data fields to be displayed in the advanced search area. Currently, the “Address” option is selected. After entering appropriate search terms, the user may select the “Go” button to execute the search. The advanced search area 133 is thereafter closed and a list of search results may be shown in the OIC display.

This functionality is enabled by entries in the blueprint tables that define the contents of the “Search” and “by” lists. These entries are referred to as search groups. Selected columns of the main blueprint table may define the search group available upon initiation as follows:

TABLE 12
CRMC_BLUEPRINT.

| Application | Event | Screen Position | Screen Type | Search Group |
|---|---|---|---|---|
| COMM_BP | INIT | 1 | SREQ | CON_001 |
| COMM_BP | INIT | 2 | SRES | |

The search group CON_{—}001 is characterized by the content it provides for the “Search” and “by” lists. They may be defined by additional blueprint tables as follows:

TABLE 13
CRMC_BL_SEARCH.

| SearchGroup | ShowKey | ByKey | Event |
|---|---|---|---|
| CON_001 | CON_01 | CON_A | CON_ADDRESS |
| CON_001 | CON_01 | CON_B | CON_NAME |

“ShowKey” and “ByKey” represent the fields that the user can choose for the query. The blueprint table entries for the “Search” list are called “ShowKey” fields. Thus, upon initiation, Table 12 prescribes the CON_{—}001 search group for screen position 1. The ShowKey and ByKey fields may be defined in additional tables:

TABLE 14
“ShowKey” definition.

| ShowKey | Show |
|---|---|
| CON_01 | Business Partner |

TABLE 15
“ByKey” definition.

| | |
|---|---|
| ByKey | By |

| | |
|---|---|
| CON_A | Address |
| CON_B | Name |

The search group CON_{—}001 in this example makes the CON_{—}01 group available in the “Search” list, and this group corresponds to “Business Partner” records according to Table 14. Also, the search group CON_{—}001 makes the CON_A and CON B “ByKey” groups available in the “by” field. Accordingly, the advanced search area defined by CON_{—}001 allows users to search among all business partner objects by either name or address. Requesting such searches triggers the CON_ADDRESS and CON_NAME events, respectively. ShowKey and ByKey groups other than those discussed here may be used.

The advanced search area also allows a user to customize the “Show” field 130 discussed above. After selecting a “Search” class (such as “All Accounts”) and a “by” field (such as “Address”), the user can name this advanced search and add it to the “Show” field using the “Add to ‘Show’” button 136. Also, the user may select an existing predefined search and delete it from the Show field using the “Remove from ‘Show’” button 137. Thus, the several search features allow the user different ways of locating responsive objects in the model.

### Model Access Methods

The methods of the model access layer are the ways that the controllers can access the model for managing objects. A blueprint table CRMC_ACCESS defines the class of model-access methods for each of the screen structures and for a given application set:

TABLE 16
CRMC_ACCESS.

| Application Set | Screen Structure | Access Class |
|---|---|---|
| Opportunity | DDIC_search | CL_CRM_MODELACCESS_01 |
| Opportunity | DDIC_list | CL_CRM_MODELACCESS_01 |
| Opportunity | DDIC_detail | CL_CRM_MODELACCESS_01 |

When an application is initiated, the main controller may refer to a definition table that associates the application with a particular application set. Thus, Table 16 lists screen structures DDIC_search, DDIC_list, and DDIC_detail for the application set “opportunity”.

The “access class” implements the interface for the model. The interface may prohibit the model from querying the controllers for user interface information. The interface may be assigned to all of the subcontrollers. Here, the interface is named IF_CRM_BSP_MODEL_ACCESS_IL and maybe defined as follows:

TABLE 17
IF_CRM_BSP_MODEL_ACCESS_IL.

IF_CRM_BSP_MODEL_ACCESS_IL
QUERY
READ
MODIFY
GET_VARIANT
CHECK_ACTIVE_TOOLBAR
CHECK_ACTIVE_TABSTRIP
PROCESS_EVENT
FILL_DROPDOWN_LISTBOX
GET_MESSAGES

The interface table (Table 17) lists methods that may be used for accessing the class, including QUERY, READ and MODIFY. The search request subcontroller may call the QUERY method (see, e.g., FIG. 7B) with different parameters depending on the type of search. The predefined searches in the “Show” field are accessible within the model, so the subcontroller calls the QUERY method with an identifier for the search to have it performed. Searches by the “Get” function and the advanced search are by their nature not defined in advance, and the subcontroller therefore calls the QUERY method with a DDIC structure containing the specified search criteria (e.g., a string in an address field). The QUERY method returns a list of keys for the objects that match the search.

Subcontrollers may call the READ method with a list of keys for the objects they seek to retrieve. The READ method returns a screen structure table containing the data of the specified objects. If changes are to be made in an object, a subcontroller may call the MODIFY method to change the object in the model. The method is called with a DDIC structure of the object with information of which fields were changed. If the MODIFY method could not update the buffer of a specified object, the MODIFY method may return that object's key to the subcontroller as an indication of the failure.

The MODIFY method does not by itself save the object changes in the model. Rather, after an object has been modified (using MODIFY), a user may choose to save the object by selecting a “Save” button or equivalent tool in the view. The controllers then call a method Before_Save to perform final checks prior to saving, such as whether saving the modified object is permitted. Absent any impediments, the controllers then call the SAVE method to actually save the changed object in the model.

Other methods may provide additional advantages. For example, a Check_Active_Tabs method allows the controllers to verify whether all tabs derived from a definition in the blueprint tables are indeed active. Some applications contain logic for hiding certain tabs and will communicate this to the controllers in response. Accordingly, data retrieved from the model may identify tabs that are not active in the user interface display. A Check_Active_Toolbars method works similarly for toolbars. That is, data retrieved from the model may identify events in toolbars that are not active in the user interface display. Thus, these methods allow applications to hide or deactivate tabs and toolbars at runtime. The PROCESS_EVENT method may be used for handling custom events, that are to be forwarded to an application. The FILL_DROPDOWN_LISTBOX method may be used for populating a drop-down list box with data. The GET_MESSAGES method may be used for retrieving application messages.

### Role-Dependent Blueprint Tables

Applications may be role-dependent such that they can be launched with different configurations depending on the user. Preferably, the user's role is registered before the application is initiated, for example by the portal where the user requests the application. The role affects what information is retrieved from the blueprint tables and thereby determines the setup of the application in this instance. The roles may be specified in a column BL View of the blueprint table as follows (only part of the table is being shown):

TABLE 18
CRMC_BLUEPRINT.

| | | | Screen | Screen | |
|---|---|---|---|---|---|
| Application | Event | BL View | Position | Type | Field Group |
| COMM_BP | INIT | SLS_MANAGR | 1 | SREQ | BP_search |
| COMM_BP | INIT | SLS_MANAGR | 2 | SRES | BP_list |
| COMM_BP | INIT | SLS_MANAGR | 3 | LIST | BP_detail |
| COMM_BP | OPP_TAB1 | | 3 | FORM | BP_detail_01 |
| COMM_BP | OPP_TAB2 | | 3 | LIST | BP_detail_02 |

If a user with a sales-manager role (SLS_MANAGR) launches the COMM_BP application, the above events with SLS_MANAGR as the BL View will be used for initialization. These events may result in a different configuration of the application than if it had been launched by a user without a specified role. Also, the blueprint tables may have initiation and other events defined for other user roles such as marketing assistant (MKT_ASSIST) and service representative (SRV_REPRES).

Other aspects of the blueprint tables may also be role dependent. For example, role-dependent field groups may display fields differently for different users. The role-dependency for field groups is established similarly to the above description. A field group table may contain the following:

TABLE 19
CRMC_FIELDGRP.

| Field Group | BL View | Field | Active |
|---|---|---|---|
| CON_DTL1 | SRV_REPRES | Field1 | On |
| CON_DTL2 | SRV_REPRES | Field1 | Off |
| CON_DTL1 | SRV_REPRES | Field2 | On |
| CON_DTL2 | SRV_REPRES | Field2 | On |

Thus, the definition of the field groups CON_DTL1 and CON_DTL2 will be used only when the user's role is SRV_REPRES. Other definitions for this field group may handle situations where the user role is not SRV_REPRES. Other examples of blueprint tables that may be role-dependent are tab strip groups, toolbar groups and search groups.

### Blueprint Application Builder

In the above, an exemplary creation of blueprint tables has been described in terms of manually assembling data structures into relational database tables. This is not the only way that the blueprint tables for an application can be generated. Design tools may automate these procedures and significantly expedite the creation process.

A blueprint application builder is a design tool that allows an application developer to combine field groups, search groups, etc. for an application into a blueprint table. As discussed previously in connection with FIG. 8B, a user interface for an application can be defined as a subset of toolbars, tab strips, etc. The application set includes all such toolbars etc. compatible with the model.

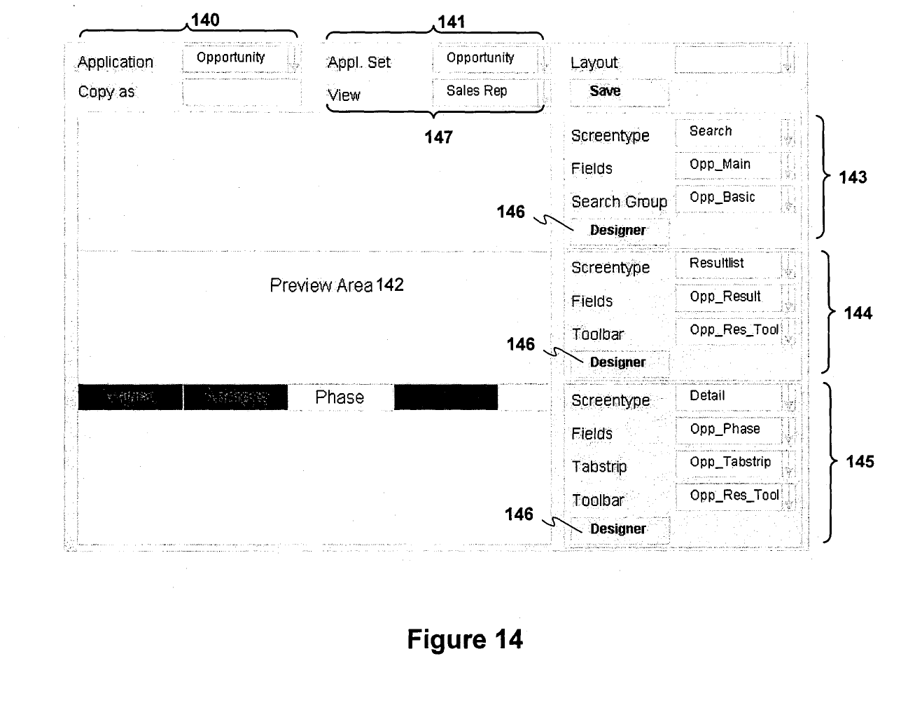

Thus, a blueprint application builder allows a developer to select between, and see resulting views of, all compatible instances of field groups, search groups, and so on. FIG. 14 shows a screen snapshot of a user interface for a blueprint application builder (BAB) with this functionality. In the application selection field 140, the developer may enter a name for the application being built (here “Opportunity”). In the application-set selection field 141, the developer may select an application set (here “Opportunity”).

The developer's task may benefit if the application is populated with live, that is, real, application data during development and displays the resulting views in a preview area. Accordingly, the BAB may run on a computer where it can access live application data (the model) and where the preview area can be displayed on a screen for the developer. The BAB may be located on the same server intended for the user interface architecture, including the blueprint tables to be created, or it may run on another computer from which the finished application can be transferred to the server.

A preview area 142 is divided in three, corresponding to different subcontrollers in the finished application. For a first screen position 143, the designer can choose between particular instances of screen types (subcontrollers), field groups and search groups according to the application set. Preferably, search groups are not used in a second screen position 144. The BAB allows the developer to choose a toolbar in addition to the screen type and field group. Screen types, field groups and toolbars can be specified also in a third screen position 145, as can tab strips, one of which is currently shown in the preview area. A “Designer” tool external to the BAB may be invoked in one or more of the screen positions by selecting a button 146. This allows detailed customizing of the screen layout, toolbars and tab strips. A View selection field 147 may be used to select a particular user role. By setting the View selector to “Sales Rep,” as shown in FIG. 14, the developer may cause the BAB to create role-dependent blueprint tables that apply to users with “sales representative” roles.

The BAB creates the blueprint tables according to the specific definitions entered by the developer. Thus, the developer need not be concerned with, or even aware of, any of the blueprint tables, because the BAB allows the developer to define the application as a specific collection of tab strips, toolbars, etc. When the developer is done with the application, the BAB may save it in memory. If the application is ready for operation, it can be launched and will contain the features that the developer selected for it in the BAB.

The BAB can be used for different purposes. One of its advantages is that it may allow existing applications to be changed, perhaps to provide them with new tool bars and tab strips to be more compatible with other applications. Another advantage is that the modified application may be saved as a new application while the existing application remains unaltered. Also, entirely new applications may be created from the existing application set by choosing a particular view configuration (pattern).

The BAB may be used for customization as has been described above. For example, the BAB may allow a customer to modify a user interface to suit the customer's needs. In response to the commands from the customer to change the user interface, the BAB copies the blueprint table entries and edits them to effectuate the changes. The BAB may store the customer's changes in a “customer” layer of the blueprint tables. The BAB may sense whether the blueprint table is being edited during development or by the customer as part of customization. Thereby, the BAB may give the customer's changes priority over the original entries such that the former is used during operation. Blueprint table entries that the customer has not changed may be used as normal.

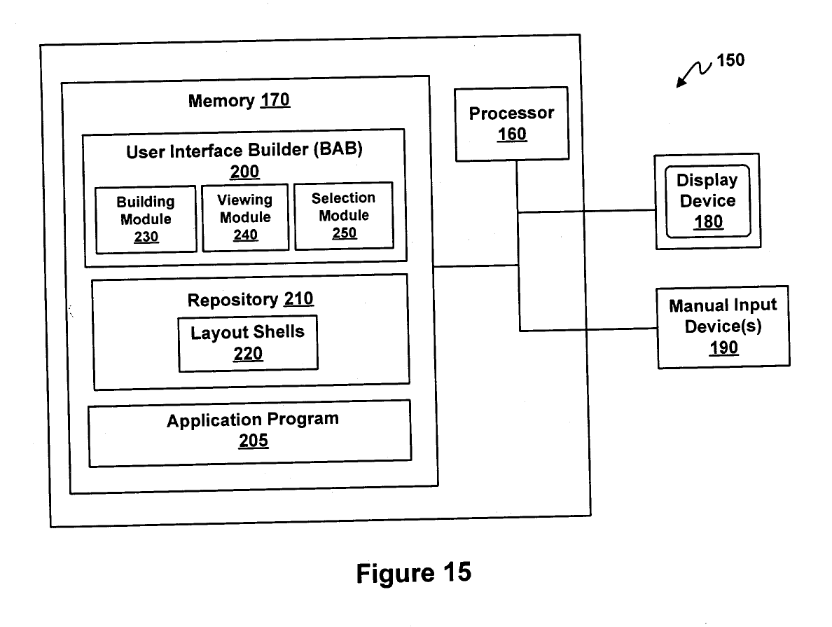

With reference to FIG. 15, the following describes an exemplary system for building user interfaces of application programs. The system 150 comprises a processor 160 for executing instructions stored in memory 170 and for managing information output on display 180 and information input on manual input device(s) 190. The memory 170 contains a user interface builder 200 capable of being used for associating an application set with an application program 205, and for selecting field groups, etc. for the application program 205.

The user interface builder 200 connects to a repository 210 which includes the application sets that are available for use with the user interface builder 200. The contents of the application sets are here referred to as layout shells 220. In this example, the repository 210 includes preconfigured layout shells 220, for example layout shells that have already been created and are currently capable of receiving application data from the model. The layout shells 220 may be independent of software application programs for which user interfaces may be built. The layout shells may be independent of a model which the application programs make up, and they may not have been created together with any of the application programs. Such independent layout shells may provide user interfaces with consistent look and feel. This may be particularly advantageous when the software application program is the product of many software developers.

An association module 230 allows the user to associate one of the layout shells 220 with the application program 205. With reference also to FIG. 14 as an example, the association module 230 is invoked when the user seeks to associate the tabstrip shown in the preview area 142 with the opportunity application program. The preview function may be provided by a viewing module 240 of the user interface builder 200 and the output may be displayed on the display device 180. The viewing module 240 may provide a preview by calling the controller 11 shown in FIG. 2. The user may make the inputs through manual input device(s) 190.

It was described with regard to FIG. 14 that the user may select an application set to work with in the BAB. A selection module 250 of the user interface builder provides this functionality. The selection module 250 may allow the user to select a subset of the layout shells 220 to be used in the user interface builder 200. For example, when the user selects the “Opportunity” application set in the BAB, the selection module 250 identifies the corresponding layout shells 220 and makes them available in the BAB.

### Embodiments in General

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the Internet.

The computer system can include clients and servers. A client and server are generally remote from each other and typically interact through a network, such as the described one. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

We claim:

1. Apparatus for building a user interface for a software application program, the apparatus comprising:
a repository of preconfigured layout shells for generating user interface displays for software application programs, the preconfigured layout shells being independent of the software application programs; and
a building module wherein a user can select at least one of the preconfigured layout shells for building a user interface, the building module using the selected layout shell to build the user interface.

2. The apparatus of claim 1, further comprising a viewing module coupled to the layout shells, whereby the user can view user interface displays generated from the layout shells.

3. The apparatus of claim 2, wherein the user can view the user interface displays using live application data.

4. The apparatus of claim 1, wherein the repository comprises a plurality of sets of layout shells, further comprising a selection module wherein a user can select a set of layout shells from which set of layout shells the user can select layout shells for building the user interface.

5. The apparatus of claim 1, wherein the apparatus provides access to a design tool for modifying the layout shells.

6. The apparatus of claim 1, wherein the apparatus is capable of using the layout shells to build a new user interface.

7. The apparatus of claim 1, wherein the apparatus is capable of using the layout shells to build a modified user interface from an existing user interface.

8. The apparatus of claim 7, wherein the apparatus does not alter the existing user interface.

9. The apparatus of claim 7, wherein the apparatus provides that a view component generated from the selected preconfigured layout shell is to be displayed in lieu of a specified view component in the existing user interface.

10. The apparatus of claim 9, wherein the apparatus provides that the modified user interface will handle the view component generated from the selected layout shell before handling the specified view component.

11. The apparatus of claim 1, wherein the preconfigured layout shells are independent of the software application programs because they were not created together with any of the software application programs.

12. The apparatus of claim 11, wherein the preconfigured layout shells are designed to be used in building user interfaces for a plurality of software application programs making up a model and wherein the preconfigured layout shells are independent of the model.

13. A repository comprising preconfigured layout shells for generating user interfaces for software application programs, the layout shells being independent of the software application programs, wherein a user can select a layout shell in the repository to generate a user interface.

14. The repository of claim 13, wherein the layout shells are independent of the software application programs because they were not created together with the software application programs.

15. The repository of claim 14, wherein the preconfigured layout shells are designed to be used in building user interfaces for a plurality of software application programs making up a model and wherein the preconfigured layout shells are independent of the model.

16. A method of building a user interface for a software application program, the method comprising:
selecting one of a set of preconfigured layout shells for generating user interface displays for a software application program, the preconfigured layout shells being independent of the software application program; and
using the selected preconfigured layout shell to build a user interface.

17. The method of claim 16, further comprising viewing the user interface display generated from the layout shell.

18. The method of claim 17, wherein the user interface display is viewed using live application data.

19. The method of claim 16, further comprising selecting the set of preconfigured layout shells from a plurality of sets of preconfigured layout shells.

20. The method of claim 16, further comprising using a design tool to modify the layout shell.

21. The method of claim 16, wherein the selected preconfigured layout shell is used to build a new user interface for the software application program.

22. The method of claim 16, wherein the selected preconfigured layout shell is used to build a modified user interface from an existing user interface for the software application program.

23. The method of claim 22, wherein the existing user interface is not altered.

24. The method of claim 22, wherein a view component generated from the selected preconfigured layout shell is to be displayed in lieu of a specified view component in the existing user interface.

25. The method of claim 24, wherein the modified user interface will handle the view component generated from the selected layout shells before handling the specified view component.

26. The method of claim 16, wherein the layout shells are independent of the software application program because they were not created together with the software application program.

27. The method of claim 26, wherein the preconfigured layout shells are designed to be used in building user interfaces for a plurality of software application programs making up a model and wherein the preconfigured layout shells are independent of the model.

28. A computer program product, tangibly stored on a machine-readable medium, for building a user interface for a software application program, the program instructions including instructions operable to cause a computer to:
receive a user's selection of one of a set of preconfigured layout shells for generating user interface displays for a software application program, the preconfigured layout shells being independent of the software application program; and
use the selected preconfigured layout shell to build a user interface.

29. The computer program product of claim 28, further comprising instructions operable to cause the computer to receive the user's selection of the set of preconfigured layout shells from a plurality of sets of preconfigured layout shells.

30. The computer program product of claim 28, further comprising instructions operable to cause the computer to display the user interface display generated from the selected layout shell.
